(19) United States
(12) Patent Application Publication
(10) Pub. No.: US 2008/0247012 A1
(43) Pub. Date: Oct. 9, 2008

(54) VARIABLE OPTICAL PHASE MODULATOR

(76) Inventors: Kuohua (Angus) Wu, Corvallis, OR (US); Andrew L. Van Brocklin, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/696,694

(22) Filed: Apr. 4, 2007

(51) Int. Cl. G03H 1/08; G02B 26/06

(52) U.S. Cl. 359/9; 359/290

(57) ABSTRACT

A variable optical phase modulator includes an array of movable, micro-electromechanical conductive plates. Each conductive plate has a substantially reflective surface, and is responsive to an applied voltage to move the conductive plate normal to a plane of the array to a predetermined distance with respect to other conductive plates in the array. The phase modulator also includes a voltage controller associated with the array of conductive plates. The voltage controller supplies a voltage to at least one of the movable conductive plates to move and position the movable plate to change the phase of electromagnetic energy reflected from the reflective surface with respect to the phase of electromagnetic energy reflected from other conductive plates in the array.

### BACKGROUND

Electromagnetic energy waves can be used to convey information by varying and interpreting the amplitude, wavelength, and phase of the energy wave. Various devices have been used to change the amplitude of broad band electromagnetic energy waves, such as visible light waves, in order to provide intensity variable information carried by the energy waves. For example, information from a visible light wave can be used to produce a three dimensional image of an object or scene that can be recorded by storing the amplitude and phase information using diffraction of coherent light. Such a recording is typically referred to as a hologram.

Certain types of holograms, known as reflection holograms, can be viewed under an ordinary white light source. Reflection holograms are often used as security features to authenticate important documents or information. For example, packaging for authentic operating system software may include a reflection hologram to show that the software has not been illegally copied. Many credit cards contain reflection holograms to allow customers and retailers to be assured that the cards are original. Holograms are used due to the difficulty in their reproduction.

Unfortunately, the complexity and cost of forming and mass producing holograms has limited the use of security holograms in common business and security practices. Recently, however, improvements in imaging and printing have allowed holograms to be directly printed using laser type printing devices. These hologram laser printing devices, however, have been limited to using amplitude modulation during printing of the information which limits the amount of information that can be imparted during printing. Additionally, holograms printed with amplitude only light modulation technique can be copied and reproduced fairly easily which reduces the desirability of using holograms created in this fashion for security purposes.

### BRIEF DESCRIPTION OF THE DRAWINGS

FIG. 1 is a side view of a variable optical phase modulator device in accordance with an embodiment of the present invention;

FIG. 2 is a side view of the variable optical phase modulator device of FIG. 1;

FIG. 3 is a side view of variable optical phase modulator device in accordance with another embodiment of the present invention;

FIG. 4 is a side view of the variable optical phase modulator device of FIG. 3; and

FIG. 5 is a perspective view of the variable optical phase modulator device of FIG. 3.

### DETAILED DESCRIPTION OF EXEMPLARY EMBODIMENT(S)

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the embodiments of the invention as illustrated herein, which would occur to one skilled in the relevant art and having possession of this disclosure, are to be considered within the scope of the invention. The following detailed description and exemplary embodiments of the invention will be best understood by reference to the accompanying drawings, wherein the elements and features of the invention are designated by numerals throughout.

The embodiments of the present invention described herein are generally directed to a variable optical phase modulator for modulating the phase of an electromagnetic energy wave, such as laser light. The phase modulator can include an array of conductive plates with each plate in the array having a substantially reflective or mirrored surface. Each of the conductive plates can be positioned at a different distance from a plane defined by the array. Each conductive plate can have a spring suspending the conductive plate from a fixed plate. A voltage controller can deliver a voltage to each of the conductive plates to move each conductive plate to a desired position in relation to the plane of the array, the fixed plate, and with respect to the other conductive plates in the array. In this way, electromagnetic energy waves directed toward the array can be reflected from each of the reflective surfaces and the varying positions of the conductive plates can cause the electromagnetic energy to be reflected at a different phase angle from each reflective surface. Thus, the array of conductive plates can produce variable phase angle information within an electromagnetic energy wave that can be carried by the energy waves for subsequent interpretation.

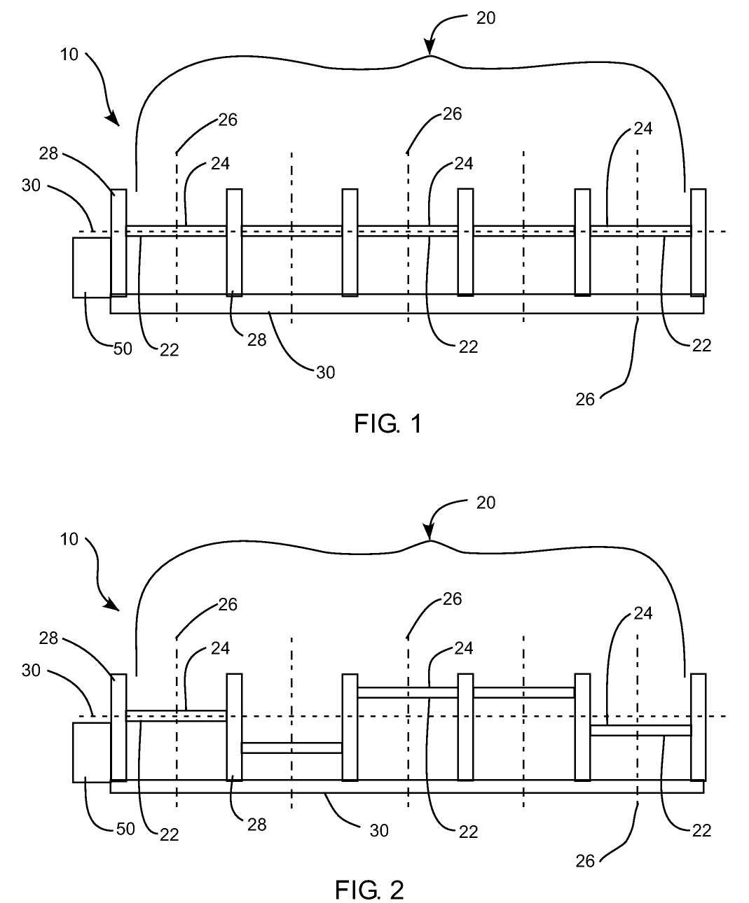

As illustrated in FIGS. 1-2, a variable optical phase modulator device, indicated generally at 10, in accordance with the present invention is shown for use in variably modulating the phase of electromagnetic energy waves. The variable optical phase modulator can include an array of movable, micro-electromechanical conductive plates, indicated generally at 20, a fixed plate or base 30, and a voltage controller 50. In one embodiment, the phase modulator 10 can be a Micro-Electro-Mechanical (MEMs) device capable of operating at the pixel or sub-pixel level.

The array of movable, micro-electromechanical conductive plates 20 can include a plurality of movable conductive plates 22. A framework or lattice 28 can support each of the movable conductive plates 22, and define the array 20. Additionally, each of the movable plates 22 can be movable within the framework or lattice 28 along an axis 26 that is parallel to the axes of movement of adjacent movable plates. Advantageously, the movable conductive plates can be positionable in a plurality of positions within the framework or lattice so that the phase modulator is not constrained to be a binary type device in which the mirrors tilt between only two positions. The array 20 can form a pixel array or sub-pixel array with each conductive plate 22 corresponding to an optical pixel or sub-pixel in an All-Points-Addressable optical pixel array.

Each of the movable conductive plates 22 can include a substantially reflective surface 24, such as a mirror. Specifically, each movable conductive plate 22 can include a mirror constructed to reflect a substantially maximum amount of light. For instance, each mirror can be a dielectric mirror having one or more layers of dielectric or metal materials deposited to form an optical coating capable of reflecting approximately 99% of the light incident on each mirror. Obviously mirrors having a lower reflectivity can also be used. However, high reflectivity can improve the performance of the phase modulator. The dielectric coating can be applied on the top of each mirror, to the bottom of each mirror, or to both the top and bottom.

Each of the movable conductive plates 22 can have a home or non-engaged position along the axis of movement 26 that is substantially co-planar with the home position of each of the other movable conductive plates. Thus, the array of conductive plates 20 can form a substantially planar surface, represented by dashed line 30, when each of the conductive plates is positioned in the home position, as shown in FIG. 1.

Additionally each conductive plate 22 can be responsive to an applied voltage which creates an electrostatic charge with respect to the base. Specifically, a voltage can move the conductive plates 22 along the axis of movement 26 and normal to the fixed plate or base 30. In this way, each of the conductive plates 22 in the array 20 can be moved along the axis 26 to a predetermined distance or position with respect to the fixed plate 30, as shown in FIG. 2.

A voltage controller 50 can be associated with the array of conductive plates 20 to move the plates to the desired positions. The voltage controller 50 can supply a voltage to at least one of the movable conductive plates 22. In one embodiment, a single voltage controller 50 can supply voltages to multiple conductive plates 22 in the array 20. In another embodiment, each conductive plate 22 can have a separate voltage controller 50.

The voltage controller 50 can provide a voltage to move a conductive plate 22 to desired distance or position with respect to the other conductive plates in the array. In this way, the charge controller 50 can position the movable plate 22 so as to change the phase of electromagnetic energy reflected from the reflective surface 24 with respect to the phase of electromagnetic energy reflected from other conductive plates 22 in the array 20.

Thus, in one embodiment, the position of each mirror or conductive plate 22 can be selected based on a voltage between each conductive plate and the base. Applying a voltage can create an electrostatic charge that draws or pushes each mirror towards or away from the base by a predetermined distance. In this way, a predetermined position of the mirror with respect to the base can be selected based on a desired change in phase of the electromagnetic energy wave hitting the phase modulator mirror. For example, the movable plates 22 can be positioned with respect to the base so as to change the phase of reflected visible light waves, infrared light waves, ultraviolet light waves, or the like.

Accordingly, in use, a voltage can be sent from the voltage controller 50 to each of the movable conductive plates 22 to move the conductive plates to a desired position with respect to the plane 30 formed by the conductive plates in the home position. Once each conductive plate 22 is positioned as desired in relation to the other conductive plates 22, an electromagnetic energy wave can be broadcast toward the array 20. The energy wave can be reflected from the substantially reflective surfaces 24 of each of the conductive plates 22. The relative positions of each of the conductive plates 22 can cause the reflected wave from each conductive plate 22 to be relatively out of phase from other conductive plates 22 positioned at different positions. In this way, the reflected wave from each conductive plate 22 can have a different phase angle with respect to one another. The reflected waves can then be collected or directed using a lens (not shown) to produce an electromagnetic wave having the desired complex phase angle variations across the wave front.

It is a particular advantage of the present invention that each of the conductive plates 22 can be positioned at a different distance with respect to one another in order to reflect electromagnetic energy waves at varied phase angles. It will be appreciated that variable phase angle information can add to the level of the information carried by the electromagnetic wave which, advantageously, makes the wave difficult to reproduce. Thus, by way of example, the movable conductive plates of the present invention can be used to create multi-dimensional holograms that are useful in security applications, such as credit card verification or CD-Rom authenticity verification.

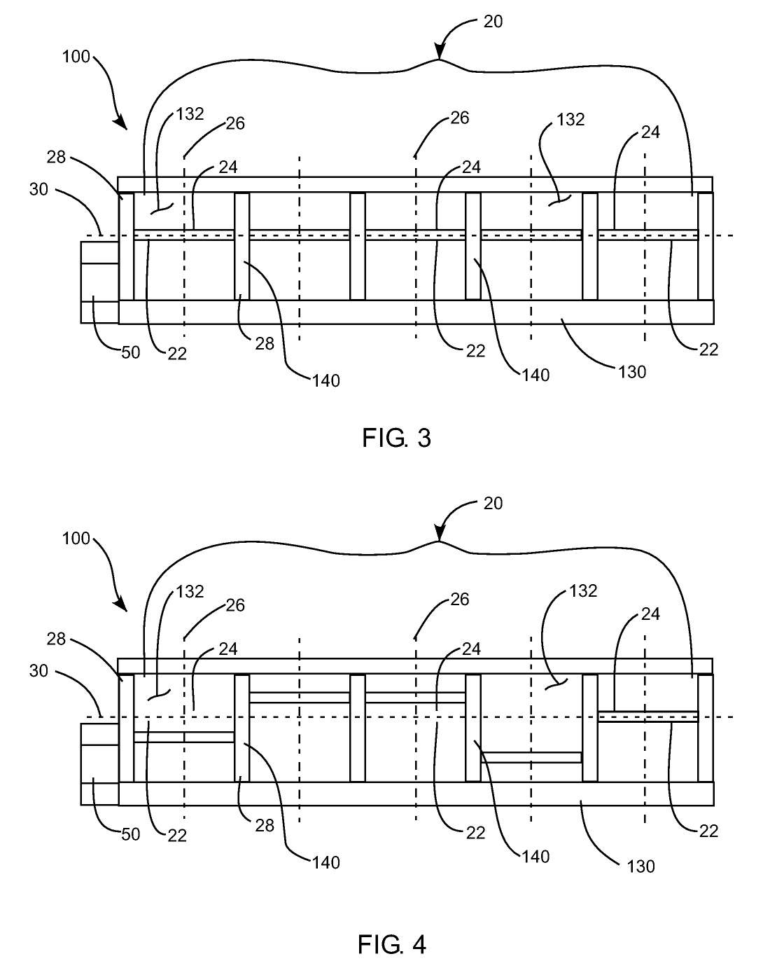

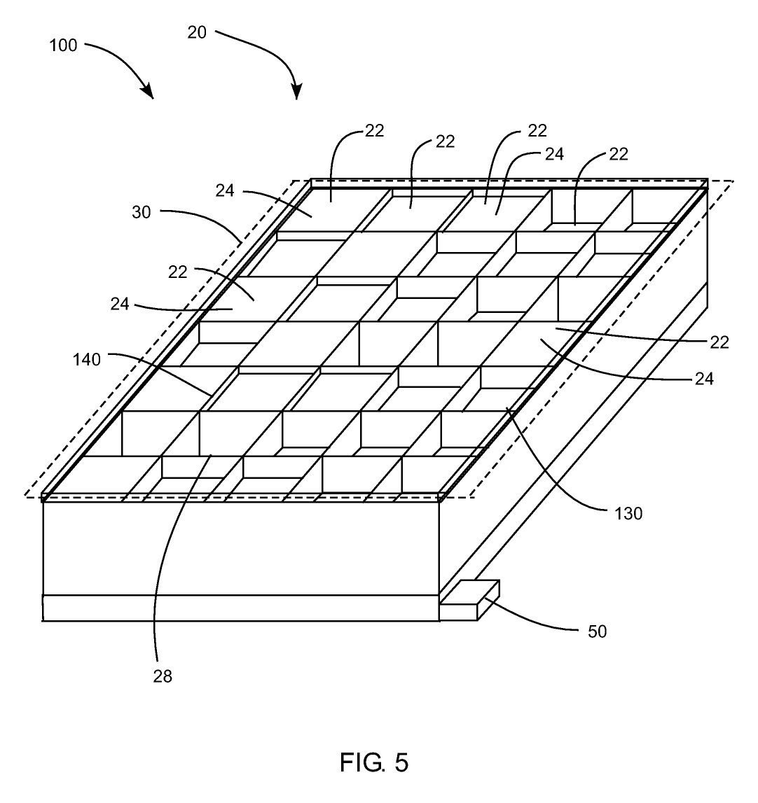

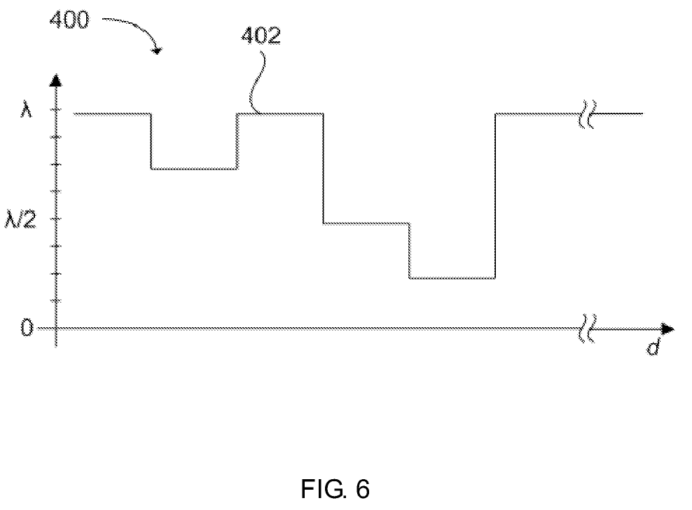

As illustrated in FIGS. 3-5, a variable optical phase modulator device, indicated generally at 100, in accordance with the present invention is shown for use in variably modulating the phase of electromagnetic energy waves. The phase modulator device 100 can be similar in many respects to the phase modulator device 10 described above and shown in FIGS. 1-2. The phase modulator device 100 can have an array of movable conductive plates, indicated generally at 20, and a voltage controller 50. Additionally, the phase modulator device 100 can include a fixed plate 130, and a plurality of micro-electromechanical springs 140.

The fixed plate 130 can include a conductive and transmissive material, as known in the art, to allow visible light to pass through the fixed plate to the array of conductive plates. The fixed plate 130 can define a gap space 132 between the fixed plate and each of the conductive plates 22 in the array 20. The gap space 132 between the fixed plate and each conductive plate 22 can vary with the position of the movable conductive plate along the axis of movement 26. Thus, each of the conductive plates 22 can be positioned in a desired position with respect to the fixed plate 130 so as to form a desired gap distance or space 132 between the conductive plate and the fixed plate.

The array of movable conductive plates 20 can form a plane 30 parallel to the fixed plate 130 when each of the conductive plates 22 is positioned in the home position, as shown in FIG. 3. In this way, the conductive plates 22 can move normal to the plane 30 formed by conductive plates in the home position, and also substantially normal to the fixed plate 130. Thus, each of the conductive plates 22 in the array 20 can be moved along the axis 26 to a predetermined distance or position in order to form a desired gap space with respect to other the fixed plate 130, as shown in FIG. 4.

The plurality of micro-electromechanical springs 140 can be associated with the framework or lattice 28 and the array of movable micro-electromechanical conductive plates 20. At least one spring 140 can suspend a movable conductive plate 22 from the fixed plate 130 within the framework or lattice 28. In one embodiment the springs 140 can form the lattice 28 supporting the conductive plates and defining the rows and columns of the array 20. In another embodiment, the springs 140 can be coupled to sidewalls 90 of the framework or lattice 28.

The springs 140 can be responsive to electrostatic energy and can move the associated conductive plate 22 to a desired position relative to the fixed plate 130 in response to a voltage from the voltage controller 50. Additionally, each micro-electromechanical spring 140 can bias at least one movable conductive plate 22 to the home position with respect to the fixed plate 130.

Thus, in one embodiment, the position of each mirror or conductive plate 22 can be selected based on a voltage between each conductive plate 22 and the base 130. Applying a voltage can create an attractive electrostatic charge that draws or pushes each mirror towards or away from the base by a predetermined distance. Alternatively, the biasing means in the arms can be configured to bias the mirrors toward the base. A voltage can then be applied between the base and mirrors to drive the mirrors from the base by a predetermined distance through an electrostatic charge. Either way, a predetermined position of the mirror with respect to the base can be selected based on a desired change in phase of the electromagnetic energy beam hitting the phase modulator mirror.

In this way, the phase of an electromagnetic wave or beam can be adjusted to a desired level between zero and 360 degrees. For example, a coherent light beam having a wavelength of 750 nm can be directed to the phase modulator 300. The position of each conductive plate relative to the base can be adjusted by at least 375 nm, or half the wavelength of the coherent light. The coherent light beam can then be reflected from the reflective surfaces of the conductive plates in the phase modulator. The phase of each light beam reflected by the conductive plates can differ from the original projected light beam by twice the change in the distance of each conductive plate with respect to the base, due to the distance each beam travels as it directed toward the mirrors and then reflected away. Thus, a change in distance or height of 375 nm, or half the wavelength of the 750 nm coherent beam, will result in a full wavelength, or 360 degree change in phase. The phase modulator is not limited to being used with any specific wavelength of coherent light. Different wavelengths of coherent light can also be used. Shorter wavelengths can allow for faster switching rates of the mirrors between desired phases since the mirrors don't have to travel as far. For instance, the mirrors may be adjusted nearly twice as fast for a wavelength of 400 nm coherent light. However, the accuracy needed to adjust a phase of 400 nm light wave is nearly twice the accuracy needed for a 750 nm light wave.

Similarly, the phase modulator 100 can be configured to have a maximum change in wavelength of less than 360 degrees. In this case, a maximum change in height of each mirror of ¼ of the light's wavelength can be sufficient to alter the phase of the wave, which can result in faster switching rates due to the shorter distance traveled by the conductive plates.

The position of each conductive plate can be varied using either digital or analog means. For example, the voltage controller can be configured to output a continuously variable voltage to each conductive plate, allowing the position of the conductive plate to be continuously adjusted to provide substantially any phase change of between 0 and 360 degrees. Alternatively, the voltage controller may be configured to output a digital voltage with 2ⁿ different voltage settings, allowing for 2ⁿ possible height adjustments, where n is an integer.

For instance, FIG. 6 shows an illustration of a one dimensional optical wavefront, with the phase of the wavefront controlled using the phase modulator 100 of FIG. 3. In this example embodiment, the conductive plates are adjusted using a driver configured to output a digital voltage with 2³ different settings, allowing for 8 different positions for each mirror between 0 and λ, or 360 degrees. This allows the reflective surface of the conductive plate to change the phase of the optical wavefront 402 at each mirror location in the array of mirrors by approximately 0, 45, 90, 135, 180, 225, 270, 315 and 360 degrees. It is also possible that the change in height of each mirror may be constrained to less than a 360 degree change in phase due to physical limitations of the distance each phase modulator mirror can move.

Thus, the phase modulator 100 of FIG. 3, comprising a two dimensional array of mirrors, can be used to alter a phase of a two dimensional optical wavefront. The phase of the wavefront can be adjusted as desired and then directed toward a lens, such as a condenser lens where the intensity or amplitude of the wavefront can be adjusted to form an image.

Additionally, the output of the phase modulator may be sent directly to holographic media to form a phase hologram. In this way, the phase modulator 100 can be used in a holographic printing system to print three dimensional holographic images. The use of a phase modulator allows the holographic images to appear three dimensional. In another example, the phase modulator can be used to encode an image. Encoding can be accomplished by incorporating a predetermined change in phase onto the holographic image. Instead of using the phase modulator to simulate a wavefront from a photographed or simulated image, the phase modulator can be controlled to form a selected phase pattern. The selected phase pattern can be based on a visual pattern, an equation used to control a height of each mirror in the phase modulator, a selection of height of each mirror in the phase modulator based on a pseudorandom pattern, and the like.

The selected phase pattern can be used to optically encode a holographic image. The optical code may be detectable by a person, or may require machine detection such as a holographic reader. The phase pattern can be used to create a holographic image which cannot be easily duplicated. For example, a hologram having a predetermined phase pattern can be attached to an important object or document. A person receiving the object or document can determine its validity based on the visual or machine detection of the selected phase pattern in the object. The holographic printing system provides a simple and inexpensive way to create document and object verification based on encoded holographic images that are difficult to reproduce. This allows people receiving objects or documents having encoded holograms attached to be ensured of their legitimacy.

The present invention also provides for a method for a method for modifying the phase angle of energy waves from an electromagnetic energy source to produce a variable phase angle in optical information carried by the electromagnetic energy source. The method can include directing electromagnetic energy from the electromagnetic energy source toward an array of movable conductive plates. Each movable conductive plate can have a substantially reflective surface that is movable in a direction normal to a plane of the array. A voltage can be applied with a voltage controller to each of the movable conductive plates to move each plate to a predetermined distance from other conductive plates in the array so as to position the reflective surface to change the phase of the electromagnetic energy reflected from the reflective surface with respect to the phase of electromagnetic energy reflected from other conductive plates in the array. The electromagnetic waves from each of the movable conductive plates can be recombined to form optical information with a variable phase angle carried by the electromagnetic energy.

The present invention also provides for a method for making a phase modulator to vary the phase angle of an electromagnetic energy wave including placing an array of movable, micro-electromechanical conductive plates on a fixed plate. The array can include a plurality of movable conductive plates with each conductive plate having a substantially reflective surface. A plurality of micro-electromechanical springs can be coupled to each of the movable conductive plates in the array such that each spring can suspend a movable conductive plate from the fixed plate. At least one voltage controller can be coupled to the array of conductive plates and the plurality of micro-electromechanical springs so as to supply an electrostatic charge to move the movable plate with respect to the fixed plate. In this way the phase reflective surface of each movable conductive plate can change the phase of electromagnetic energy reflected from the reflective surface with respect to the phase of electromagnetic energy reflected from other conductive plates in the array.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A variable optical phase modulator, comprising:
a fixed plate;
an array of movable, micro-electromechanical conductive plates associated with the fixed conductive plate, each conductive plate having a substantially reflective surface separated from the fixed plate by a variable gap distance;
a plurality of micro-electromechanical springs associated with the array of movable micro-electromechanical conductive plates, each spring suspending a movable conductive plate from the fixed plate; and
at least one voltage controller, associated with the array of conductive plates, and configured to supply an electrostatic charge with respect to the fixed plate to move the movable plate and change the phase of electromagnetic energy reflected from the reflective surface with respect to the phase of electromagnetic energy reflected from other conductive plates in the array.

2. The modulator of claim 1, wherein each conductive plate is responsive to an applied voltage to position the movable plate to a predetermined gap distance from the fixed plate.

3. The modulator of claim 1, wherein the array of conductive plates is oriented parallel to a plane of the fixed plate and each conductive plate is movable in a direction normal to the plane of the fixed plate.

4. The modulator of claim 1, wherein each of the conductive plates in the array is a pixel plate corresponding to an optical pixel in an All-Points-Addressable pixel array.

5. The modulator of claim 1, wherein each micro-electromechanical spring biases at least one movable conductive plate to a home position with respect to the fixed plate.

6. A variable optical phase modulator, comprising:
an array of movable, micro-electromechanical conductive plates with each conductive plate having a substantially reflective surface, and each conductive plate being responsive to an applied voltage to move the conductive plate normal to a plane of the array to a predetermined distance with respect to a fixed base plate; and
a voltage controller, associated with the array of conductive plates, and configured to supply a voltage to at least one of the movable conductive plates to move the plate to the predetermined distance so as to position the movable plate to change the phase of electromagnetic energy reflected from the reflective surface with respect to the phase of electromagnetic energy reflected from other conductive plates in the array.

7. The modulator of claim 6, further comprising:
a plurality of micro-electromechanical springs associated with the array of movable micro-electromechanical conductive plates, each spring suspending a movable conductive plate from the fixed plate.

8. The modulator of claim 6, wherein each conductive plate is responsive to an applied voltage to position the movable plate to a predetermined gap distance from the fixed plate.

9. The modulator of claim 6, wherein the array of conductive plates is oriented parallel to a plane of the fixed plate and each conductive plate is movable in a direction normal to the plane of the fixed plate.

10. The modulator of claim 6, wherein each of the conductive plates in the array forms a pixel plate corresponding to an optical pixel in an All-Points-Addressable pixel array.

11. The modulator of claim 6, wherein each micro-electromechanical spring biases at least one movable conductive plate to a home position with respect to the fixed plate.

12. A method of modifying the phase angle of energy waves from an electromagnetic energy source to produce a variable phase angle for the energy waves, comprising:
directing electromagnetic energy from the electromagnetic energy source toward an array of movable conductive plates, each movable conductive plate having a substantially reflective surface movable in a direction normal to a plane of the array;
applying a voltage with a voltage controller to each of the movable conductive plates to move each plate to a predetermined distance from a base plate so as to position the reflective surface to change the phase of the electromagnetic energy reflected from the reflective surface with respect to the phase of electromagnetic energy reflected from other conductive plates in the array; and
combining the electromagnetic waves from each of the movable conductive plates to form optical information with a variable phase angle carried by a combined electromagnetic wave.

13. The method of claim 12, further comprising:
directing the combined electromagnetic wave to a predetermined location on a holographic media to form a holographic image including the variable phase angle optical information on the holographic media.

14. A method as in claim 13, further comprising:
detecting the variable phase angle optical information in the holographic image to enable a person to verify the holographic image is authentic.

15. A method of using a phase modulator to vary the phase angle of an electromagnetic energy wave, comprising:
sending a voltage from a voltage controller in the phase modulator to each of a plurality of movable conductive plates to move the conductive plates to a desired position with respect to a fixed base plate, each of the conductive plates being positionable at a different distance from the fixed base plate;
broadcasting a primary electromagnetic energy wave toward the plurality of movable conductive plates in the phase modulator;
forming a plurality of reflected electromagnetic waves by reflecting the primary electromagnetic wave from a substantially reflective surface of each of the plurality of conductive plates such that each of the plurality of reflected electromagnetic waves has a phase angle dependent on the distance traveled by the primary electromagnetic wave before being reflected by the respective conductive plate;
directing the plurality of reflected electromagnetic waves with a lens to produce a combined electromagnetic wave having complex phase angle variations across a wave front.

16. The method of claim 15, further comprising:
directing the combined electromagnetic wave to a predetermined location on a holographic media to form a holographic image including the complex phase angle variations on the holographic media.

17. A method as in claim 16, further comprising:
detecting the complex phase angle variations in the holographic image to enable a person to verify the holographic image is authentic.

18. A method for making a phase modulator to vary the phase angle of an electromagnetic energy wave, comprising:
placing an array of movable, micro-electromechanical conductive plates on a fixed plate, the array including a plurality of movable conductive plates with each conductive plate having a substantially reflective surface;
coupling a plurality of micro-electromechanical springs to each of the movable conductive plates in the array, each spring suspending a movable conductive plate from the fixed plate; and
coupling at least one voltage controller to the array of conductive plates and the plurality of micro-electromechanical springs so as to supply an electrostatic charge to move the movable plate with respect to the fixed plate and change the phase of electromagnetic energy reflected from the reflective surface with respect to the phase of electromagnetic energy reflected from other conductive plates in the array.
